(19) United States
(12) Patent Application Publication
(10) Pub. No.: US 2021/0358023 A1
(43) Pub. Date: Nov. 18, 2021

(54) ELECTRONIC STOREFRONT SYSTEM AND A METHOD OF PROVIDING AN ELECTRONIC STOREFRONT

(71) Applicant: Lindsy D. Melcher, Boca Raton, FL (US)

(72) Inventor: Lindsy D. Melcher, Boca Raton, FL (US)

(21) Appl. No.: 17/319,972

(22) Filed: May 13, 2021

Related U.S. Application Data
(60) Provisional application No. 63/025,254, filed on May 15, 2020.

(51) Int. Cl. G06Q 30/06; G06Q 50/00; G06F 8/61; G06F 16/22; G06F 16/9535; H04L 29/08; G06F 3/14

(52) U.S. Cl. CPC G06Q 30/0643; G06Q 50/01; G06F 8/61; G06F 16/22; G06Q 30/0633; H04L 67/10; G06F 3/14; G06Q 30/0623; G06F 16/9535

(57) ABSTRACT

An electronic storefront having improved display formats for blogging, job offers, messaging, selling and social media. A system and method of providing the electronic storefront.

### FIELD OF THE INVENTION

The invention relates an electronic storefront having improved display formats for blogging, job offers, messaging, selling and social media. The invention also relates to a system and method of providing the electronic storefront.

### BACKGROUND

In today's society searching within the online worldwide web has become a part of most humans' everyday life. The first link to this new world started on desktop computers, then transgressed onto laptops, iPads, and into ones very own hands upon their own personal user interface device. Now, within seconds one can access this global network upon the touch of a glass screen. This has led many to living a life online for all to see, physically near and far, yet technically close by through the creation of social media. As the technology evolved, so did everything within it, leading to the invention of apps, the easy to use application of all media on ones own personal device. Today, most internet access is through one of these apps, including social media platforms. Although, the social media world via the internet through these applications is revolutionary, it does have disadvantages.

For instance, Instagram is used solely for photos, exemplifying one's life through image as Twitter shows that exact life, yet expressed mostly through ones word, whereas Facebook, globally as the highest ranked daily user social media, one is able to show life through both of these outlets. Although, a problem is that Facebook is constantly updating their front end, making it not user friendly. Facebook's set up is very complicated due to the extent of content upon their app making it hard to navigate for the older generations. Instagram is simpler, yet is suited more for the creative minds, due to photography being the center point of the media, which cuts the amount of actual posting users exponentially. This has led to a silent, yet well-known popularity competition among the skills of one's photography abilities behind and in front of the screen. Due to the fact that many now look up to these “life photos,” it has stopped many from wanting to post to their own page, a main purpose of the app in the first place. As well as, it also has a way higher percentage of users in the younger generation, because of their fondness with instant momentary photography. Twitter is a great outlet to express one's opinions, shared ideas, and the like between users, although, it is limited on how far one can reach because it is solely based on text, cutting the younger generations out exponentially. As well as all of these issues, the greatest blockage to users engaging more on all the social media platforms, is the likes feature. This feature makes people feel unworthy in moments and has led to living lives that they truly don't live. The point of charting our lives was to remember the good moments of life, yet not live those moments at the cost of others approval. All the social media platforms have the right idea, to bring people globally together, instantly, freely, yet not quite as efficiently as they could.

### SUMMARY OF THE INVENTION

The 1LM system is a greatly improved, simplified and modified combination of all of the elements held within the different social media platforms described above, yet without excluding any race, any age, or any person. The 1LM system has designed from the ground up so that a five year old can easily navigate the system, as well as an eight-five year old within minutes. The is made possible because there are minimal words. The majority of aspects within the 1LM system are exemplified by simple, easily identifiable icons so that no one is discriminated against. The use of icons allows people who speak different languages to communicate quickly and efficiently when engaging in an array of important matters housed within the system. When speaking, a user can choose the “icon response” where the user is able to send simple icons to make sure the product has arrived on time and so forth. The system also can hide the user's true identity to the outside world in the business and messenger sections by letting the user design their own ‘avatar,’ so that the user does not have to worry about stalkers or discrimination based on age, race, and other varying factors. This is a feature that no other social media has integrated, yet is a powerful tool in order to secure one's safety in business, in thought, in life. The only place where the user's true identity is expressed is on their personal private profile page in which only the user's “light links” can see if the user chooses so.

The 1LM system's profile includes aspects of all the other social media platforms out there and numerous additional features in one simple, yet professional place. The 1LM system encompasses a live story, similar to but different than Snapchat, a “thoughts” section similar to but different than Twitter, a photo upload section similar to but different than Instagram, and a posts area at the bottom similar to but different than Facebook. A preferred embodiment of 1LM profile excludes use of a “likes” feature, which is probably the most sought after feature within the other apps, yet is the most destructive. In this manner, the 1LM system gives the user the ability to comment in which the amount of comments will not be shown and the ability to have views in which all users can see the number of views, yet the user can only see who viewed the post. The 1LM system can be operated in a specific way that all users will receive views, thus ensuring that all will feel more fulfilled. No matter ones age, or race, at the end of the day the user just wants to be heard, to be seen, and to be free. The 1LM system ensures that when the user is ready, the user will be ready to post again.

Another feature of a preferred 1LM system is that there are no followers, only “light links,” for a first user can only follow someone if another second user is following the first user back avoiding fake accounts and unwanted negative attention. This completely eradicates the popularity competition, and even brings famous people down to the online social level as non-famous people. Users will soon realize, the less links, the better, ensuring stronger bonds between each other, and inevitably with themselves.

Another unique feature about the 1LM system's profile page is that it can be set-up like a blog, even with a new, never been used feature of a search bar above the posts, so one is able to search through all the posts of the selected account. In a preferred embodiment, the profile page has the user in mind because all of the user's personal posts, messages, and photos can be automatically deleted after a set time period, for example 22 days, so this leaves no one able to blackmail another, and as the user changes over time, the user does not have to worry about past embarrassing childhood posts, because the user will not exist anywhere but in their personal memory, where they rightfully belong, their own memory. The automatic deletion set time period can be set by the user to any desire time period.

The 1LM system can be designed to account for power with the people, for if users are going to be using the system, the users are going to have control not only over what they decide to publicly post within the system, but what the users publicly want to keep posted. A huge disadvantage of conventional other social media platforms is that many users would like to go back and delete some of their embarrassing posts, such as dramatic break up posts from months or even years ago, yet it would take months or even years to uncover these posts leaving ones past personal life choices completely in the hands of others. Nowadays some companies like to view a perspective employee's social media account before hiring them in order to understand what type of person they are. When people first signed up with social media accounts they were not thinking how serious keeping chart of their past could be to their reputation. Thus, the 1LM system provides a user the solace in not having to worry about the past anymore, and keeping all users in real time, where we all naturally belong. Although, if a user does desire to retain a post, photo, thought, or video from their personal profile, the user will have the option to add the post, photo, thought, or video to the user's “akashic records” account. For this is where the user's account will go once they pass on, so that the user's future great grandchildren can have an idea of who their inspiring, noble great grandparent was, because the user will be able to decide what is left for the user's future generations to see. This feature is revolutionary solely because the feature innately sets up the user's mind to think moment to moment of the future, by choosing the past the user wants to remember, the past that we all now can remember.

The Akashic Records feature also ensures the user's own personal rights. When people post on Facebook, Instagram, Twitter, and other conventional social media, they instantly sign away their rights to those images in order to use the application. Personal data is then stored in the hands of the owners of conventional media, strangers with or without the good will of the people in mind. In contrast, since all data will be automatically deleted after a set time period in the present preferred 1LM system, no user will have to worry about their photos being stored anywhere, or anytime because the photos will be deleted. There will be no company funds going into taking away the privacy of the user's own personal life. Since the 1LM system can be set up so simply, the 1LM system is also very easy to deactivate and delete ones account and akashic record permanently, a feature that is very hard to find on any other social media front end platform. Since deletion of one's account from conventional social media, conventional social media has transgressed into something far more than it was originally intended. Instead of connecting people by offering quick and accessible ways conventional social media is now more of a permanent inaccurate record of one's life.

The point of social media is for one to engage, to learn, to grow. Twitter, Instagram, and Facebook and other conventional social media make it hard to access personal messaging features. One has to click multiple buttons and even open new apps in order to connect to other users one on one. In contrast, the 1LM system has a simple icon (button) at the bottom to take the user to the messenger page. On the messenger page, the user is able to send messages to clients who just bought their product and give quick shipping announcements or speak to friends they want to meet up with later that night. The communication possibilities are endless using the messenger page. Furthermore, users are shown by their ‘avatar’ keeping all identities completely anonymous, as well as not showing their name avoiding discrimination. The user will learn to identify other users by their ‘avatar’ unless the users are ‘light linked,’ in which case the light linked users will be able to see each other's personal information.

The 1LM system also provides a new, never been used feature called “quick reply” that simply is an icon, such as an arrow, in the top center that clicks downward and lets one respond message by message far more quickly and efficiently without leaving the original page. The less clicks, the better, and that is something that the present 1LM system has mastered.

In an expanding world full of ever changing life, the bond between the intangible and tangible will keep growing thin, so we can only hope that the future is filled with greater abundance, laughter, and joy, online, and in real life, even if those become the same thing. The 1LM system is created so that no matter what is to come, that we as a people can freely share and accept our brilliantly diverse minds in one place, one world, one moment.

### BRIEF DESCRIPTION OF THE DRAWINGS

FIG. 1 illustrates a system for user to connect to server.

FIG. 2A illustrates a flow chart of the pages within the application.

FIG. 2B illustrates a flow chart of the quick reply.

FIG. 2C illustrates a flow chart of the light links.

FIG. 2D illustrates a flow chart of how the system automatically deletes information (messages, photos, blog statements) and saves information to the akashic records.

FIG. 3 illustrates a screenshot of the home screen.

FIG. 4 illustrates a screenshot of the “sign-up” page.

FIG. 5 illustrates a screenshot of what happens when one clicks “anonymous.”

FIG. 6 illustrates a screenshot of the page the user is directed to upon logging in.

FIG. 7 illustrates a screenshot of the notifications tab on the home page.

FIG. 8 illustrates a screenshot of the user's personal account information page.

FIG. 9 illustrates a screenshot of the user's edit profile page.

FIG. 10 illustrates a screenshot of the user's edit store page.

FIG. 11 illustrates a screenshot of the user's products displayed within their online store.

FIG. 12 illustrates a screenshot of the user's settings page.

FIG. 13 illustrates a screenshot of the user's analytics page.

FIG. 14 illustrates a screenshot of the user's financial settings page.

FIG. 15 illustrates a screenshot of the user's sales page.

FIG. 16 illustrates a screenshot of the user's customer list page.

FIG. 17 illustrates a screenshot of the user's personal card information page.

FIG. 18 illustrates a screenshot of the user's filing data page.

FIG. 19 illustrates a screenshot of the user's verification page.

FIG. 20 illustrates a screenshot of the user's accounting page.

FIG. 21 illustrates a screenshot of the user's messenger page.

FIG. 22 illustrates a screenshot of the user's “quick reply” messenger page.

FIG. 23 illustrates a screenshot of a “new” message page.

FIG. 24 illustrates a screenshot of a user's “light links” list.

FIG. 25 illustrates a screenshot of a user's shopping page.

FIG. 26 illustrates a screenshot of a user's empty cart.

FIG. 27 illustrates a screenshot of a user's wishlist.

FIG. 28 illustrates a screenshot of a user's previous purchases.

### DETAILED DESCRIPTION

In the following description, for purposes of explanation and not limitation, specific details are set forth, such as particular networks, communication systems, computers, terminals, devices, components, techniques, storage devices, data and network protocols, software products and systems, operating systems, development interfaces, hardware, etc. in order to provide a thorough understanding of the present invention, which can apply, function and operate to and with any suitable user interfaces to allow communication between users. However, it will be apparent to one skilled in the art that the present invention may be practiced in other embodiments that depart from these specific details. Detailed descriptions of well-known networks, computers, digital devices, storage devices, components, techniques, data and network protocols, software products and systems, development interfaces, operating systems, and hardware are omitted so as not to obscure the description of the present invention.

The invention will now be explained with reference to the attached non-limiting FIGS. The operations described herein can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

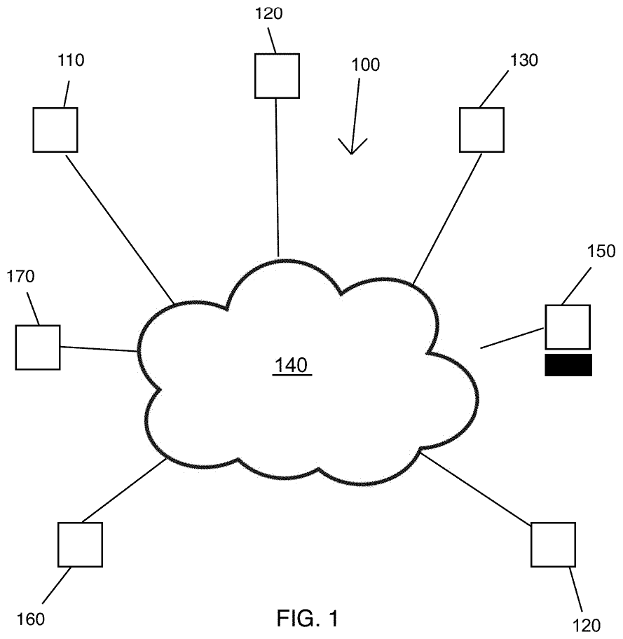

FIG. 1 describes a system 100. The system 100 comprises a plurality of user interface devices 120 and a main server 150 interconnected via a communication network 140.

Various networks 140 may be implemented in accordance with embodiments of the invention, including a wired or wireless local area network (LAN) and a wide area network (WAN), wireless personal area network (PAN), telephone network, and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications, such as by the network 140. Some suitable communications protocols may include TCP/IP, UDP, OSI, Ethernet, WAP, IEEE 802.11, Bluetooth, Zigbee, IrDa or any other desired protocol. Furthermore, components of the system may communicate through a combination of wired or wireless paths.

The 1LM system 100 can be accessed via any user interface device 120 that is capable of connecting to the main server 150. The user interface device 120 comprises a display, and preferably a touch screen display, a video camera and a microphone for inputting sound. An exemplary user interface device 120 contains a web browser or similar program, allowing in some embodiments for a secure SSL connection, and able to display HTML and CSS. This includes user interface devices 120 such as tablets, iPads, Mac OS computers, Windows computers, e-readers, and mobile user devices such as the iPhone, Android, and Windows Phone. Preferably, the user interface device 120 is a tablet or phone. The user interface devices 120 can connect to the server 150 via the internet and/or wirelessly, such as through a mobile telephone network 140, and/or any other suitable medium. User interface devices 120 are able to communicate to the main server 150 so that content can be started on one user interface device 120 and later continued on a separate user interface device 120. The user interface device 120 preferably includes an I/O interface that allows a user to interact with the system 100. The I/O interface may include any hardware, software, or combination of hardware and software.

The computer processing unit (CPU) of the user interface device 120 can be implemented as a conventional microprocessor, application specific integrated circuit (ASIC), digital signal processor (DSP), programmable gate array (PGA), or the like. The CPU executes the instructions that are stored in order to process data. The set of instructions may include various instructions that perform a particular task or tasks, such as those shown in the appended flowcharts. Such a set of instructions for performing a particular task may be characterized as a program, software program, software, engine, module, component, mechanism, or tool. The memory may include random access memory (RAM), ready-only memory (ROM), programmable memory, flash memory, and the like. The memory, include application programs, OS, application data etc. The exemplary computing device 120 also includes a network module connected to an antenna to communicate with rest of the system 100.

The main server 150 described herein can include one or more computer systems directly connected to one another and/or connected over the network 140. Each computer system includes a processor, non-volatile memory, user input and user output mechanisms, a network interface, and executable program code (software) comprising computer executable instructions stored in non-transitory tangible memory that executes to control the operation of the main server 150. Similarly, the processors functional components formed of one or more modules of program code executing on one or more computers. Various commercially available computer systems and operating system software can be used to implement the hardware and software. The components of each server can be co-located or distributed. In addition, all or portions of the same software and/or hardware can be used to implement two or more of the functional servers (or processors) shown. The main server 150 can run any desired operating system, such as Windows, Mac OS X, Solaris or any other server based operating systems. Other embodiments can include different functional components. In addition, the present invention is not limited to a particular environment or main server 150 configuration. Preferably, the main server 150 is a cloud based computer system.

The main server 150 preferably includes a web server and the query processing unit. The web server receives the user requests and sends it to the query processing unit. The query processing unit processes the request and responds back to the user interface device 120 via the web server. The query processing unit fetches data from the database server if additional information is needed for processing the request. The database is stored in the non-volatile memory. The term “database” includes a single database and a plurality of separate databases. The main server 150 can comprise the non-volatile memory or the main server 150 can be in communication with the non-volatile memory storing the database. The database can be stored at different locations. Software program modules and data stored in the non-volatile memory the main server 150 may be arranged in logical collections of related information on a plurality of computer systems having associated non-volatile memories. The software and data may be stored using any data structures known in the art including files, arrays, linked lists, relational database tables and the like.

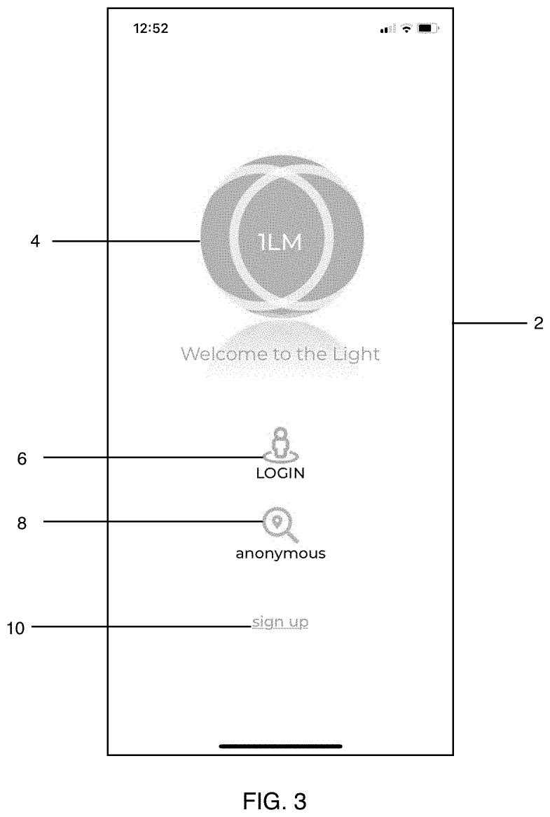

The server 150 and user interface devices 120 are programed to perform the methods described herein. FIGS. 3-28 show exemplary screenshots displayed on the user interface device 120. The user's information and other information discussed herein is stored in the database.

FIG. 3 shows a screenshot of the login page 2 for the system 100. The login page 2 shows the 1LM logo 4, a login icon 6, an anonymous icon 8, and sign up icon 10. The anonymous icon 8 can be selected by a user when they want to remain anonymous when using the system 100. The login icon 6 can be selected for a user to be able to enter the site under a profile giving one the ability to follow other shops and comment on recent posts with their given name.

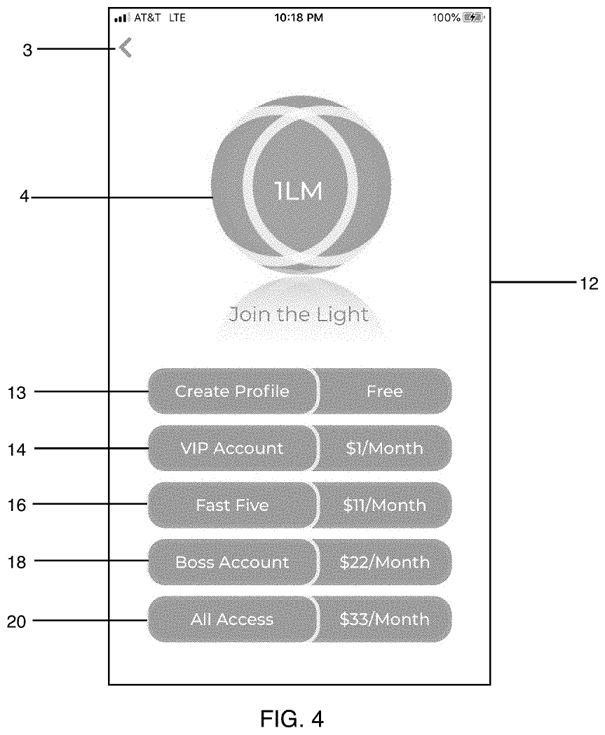

FIG. 4 shows a screenshot of a sign up page 12. The sign up page 12 include the 1LM logo 4. The sign up page 12 provides the user with different options on how to use the system 100. Examples include create a free profile 13, get a VIP Account 14, get a Fast Five account 16, get a Boss Account 18, or an All Access Account 20. The user can click the back button icon 3 to return the login page 2. Prices for each of these can also be provided as shown in FIG. 4.

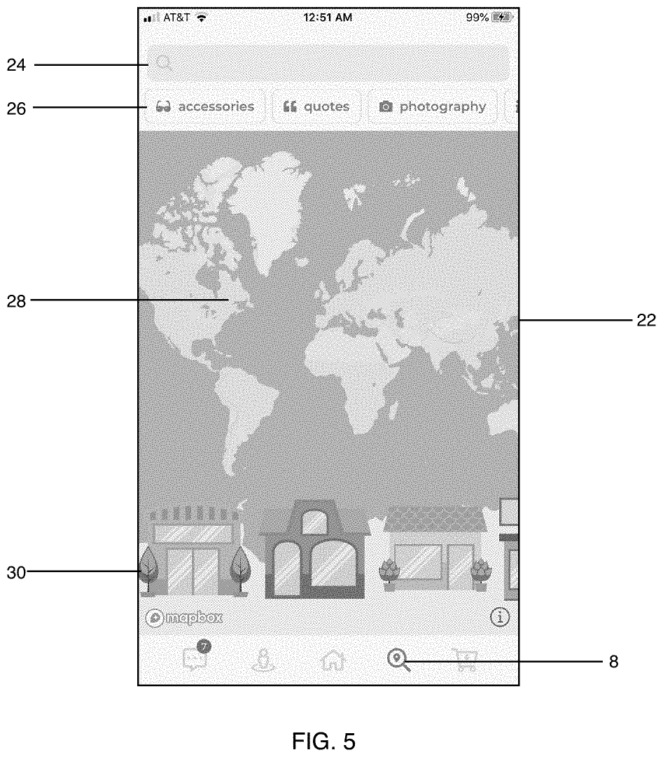

FIG. 5 shows a screenshot of the search page. The anonymous option with the icon 8 on the home page 2 goes to this page. On this page users can search by clicking the search bar 24 within the system 100 for other products, services, posts, people, and information. The user can click a category 26 to make the search more refined. The user can click the map 28 to search for local and global businesses, services, posts, people, and information. At the bottom of the map 28 the user can click the recent advertisements, and see local, and new online store fronts 30.

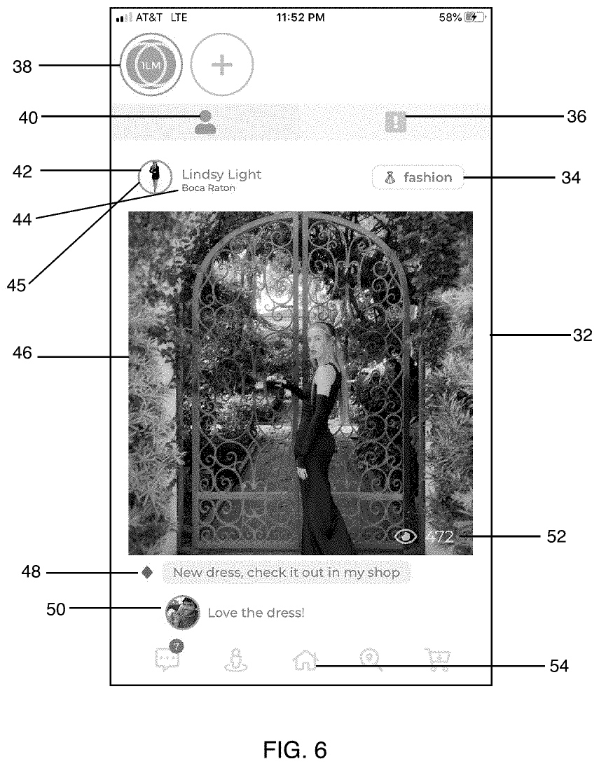

FIG. 6 shows a screenshot of the users home page 32. On this page the user will see recent uploaded posts 46 within a selected category 34 under the light linked accounts and followed stores recent posts tab 40. The user will also see recent notifications under the notifications tab 36. At the top of the home page 32 the user will see recent uploaded stories 38 posted by light linked accounts 114 and followed stores 102. Under each user post 46 is a user post caption 48 further explaining their photo post. Other users can comment 50 on home page 32 user posts 46. The user profile photo, name and story accessibility if s user posted a recent story 42 is displayed above user post 46. The user post 46 is displayed on the users published profile 45 which is accessed by clicking the user profile photo 42. The location of the user 44 is displayed under the user profile photo, name and story accessibility if the user posted a recent story 42. On the recent user post 46 the user can see visible user views 52 expressing how many other users have already decided to view the given user post 46. When the user is active on the home page 32, the home page icon 54 can be highlighted at the bottom of the home page 32 screen.

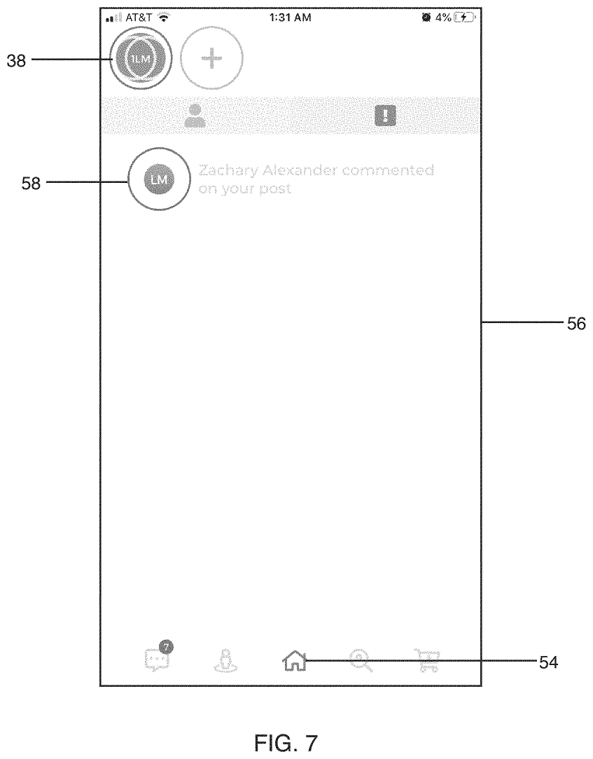

FIG. 7 shows a screenshot of the notifications page 56. On this page 56 the recent uploaded stories 38 are still visible at the top of the page 56. The most recent unseen notifications 58 are listed in order from top to bottom. The home icon 54 is still highlighted at the bottom of the notifications page 56.

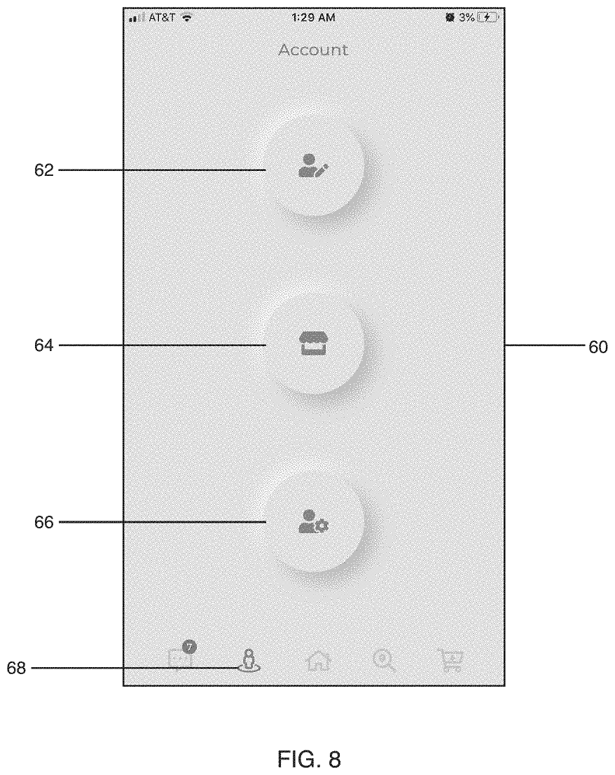

FIG. 8 shows a screenshot of the personal user account page 60. On this page 60 the user has three button options to either choose to click the user profile setting icon button 62, the user store settings icon button 64, or the user account settings icon button 66. The user personal account icon 68 will be highlighted when user is on this account settings page 60.

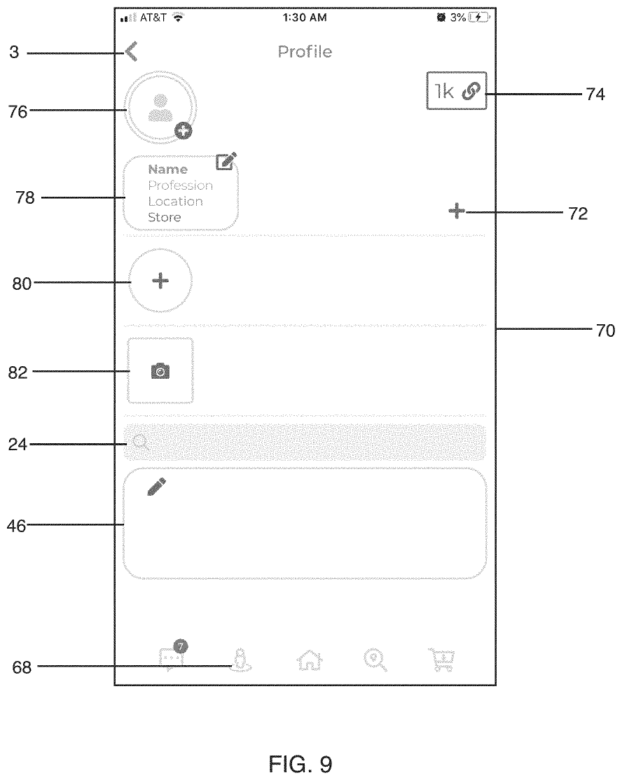

FIG. 9 shows a screenshot of the personal user profile settings page 70. On this page 70 the user can click the back button 3 to return to user account page 60. The user can add a profile photo 76. They can add a profile background image 72. The user can add a profile bio 78 which includes their name, profession, location, and link to their store on this profile settings page 70. These options allow the user to customize their personal profile page 70. The user can link personal videos 80 from established online medias available on the network 140 or directly onto this app from their personal user interface 120. The user can link personal photos 82 from established online medias available on the network 140 or directly onto this app from their personal user interface 120. The user can link personal posts 84 from established online medias available on the network 140 or directly onto this app from their personal user interface 120. This is so the user's profile can appear as a blog encompassing all of the user's online published work. The amount of light links are displayed in the light links icon box 74 publicly. Other light links 114 can view their published profile 45. These light links 114 can comment 50 on shared videos 80, shared photos 82, and shared posts 46. The user can search through the selected users personal profile posts 46 via the search bar 24 and view them on the home page 32. The user personal account icon 68 will be highlighted when user is editing this personal profile settings page 70.

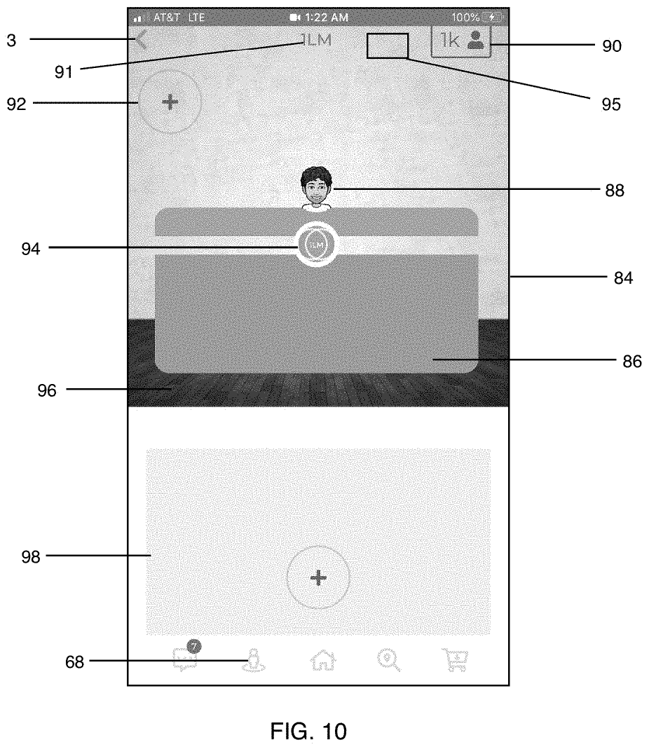

FIG. 10 shows a screen shot of the personal user store settings page 84 which gets published as the user's public online store 102. On this page 84 the user can click the back button 3 to return to user account page 60. The user can add a store profile photo 92 as well as display a store story 104. The user can add a store profile background image 96. The users store name 91 is displayed in the upper center of page. Every store 102 has an online store desk 86 with the ability to add a personal avatar 88 behind the desk 86. The amount of light followers 116 is displayed in the upper right corner in the light followers icon box 90. The user can add their store logo 94 in the center of the store desk 86 (also referred to as a light desk). The user can add photos 82 and/or videos 80 to the light show 98 which is a public carousel of slides. The users personal account icon 68 will be highlighted when user is editing this online store settings page 84. A purse 95 shows a user's total purchases on the 1LM system, or subsets of the purchases, such as by store or type of product/service purchased. The user can have the option to restrict who can view the purse 95, such as only store owners, light links, or any other.

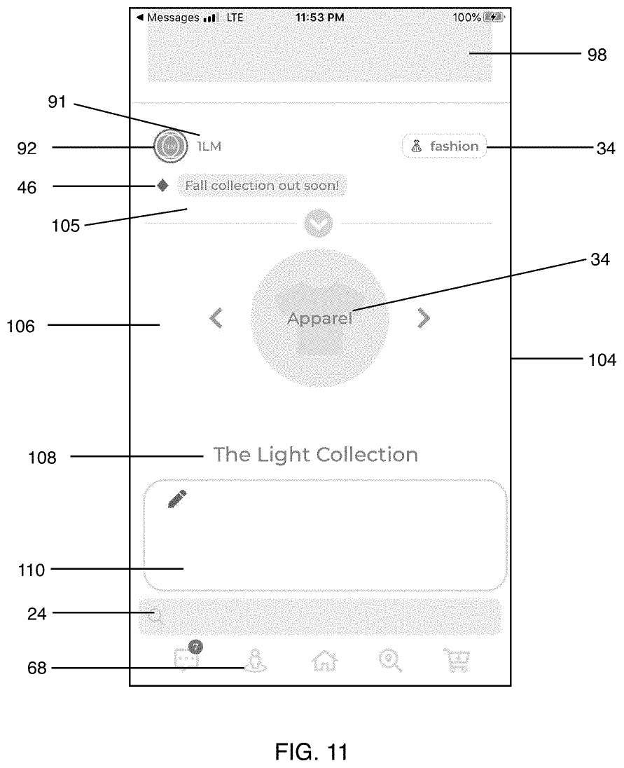

FIG. 11 shows a screenshot of the user store settings page continued 104. The user can add photos 82 and/or videos 80 to the light show 98 which is a public carousel of slides on their public online store 102. The user can add daily posts 46 to the store blog posts section 105 on the public online store 102. The store name 91 and the user store profile photo and story 38 accessibility if a recent Story 38 was posted 92 is displayed at the top of the store blog post 105. The category 34 is displayed at the top right corner of every store blog post 105. The user can add products to the categories carousel 106. Each category carousel 106 will display the chosen category 34 and that specific categories products 112. Below the category carousel 106 the categories title 108 will be displayed as well as the category bio 110. The user can search through that given categories 34 specific products 112 using the search bar 24. The users personal account icon 68 will be highlighted when user is editing this online store settings page continued 104. A colored check mark or other shaped identifier, such as blue, will appear by a product once a number of the products has sold meets a set number of sales to identify higher selling or more desirable product. A colored check mark or other shaped identifier, such as blue, once a number of sales by a store has sold meets a set number of sales to identify higher selling store.

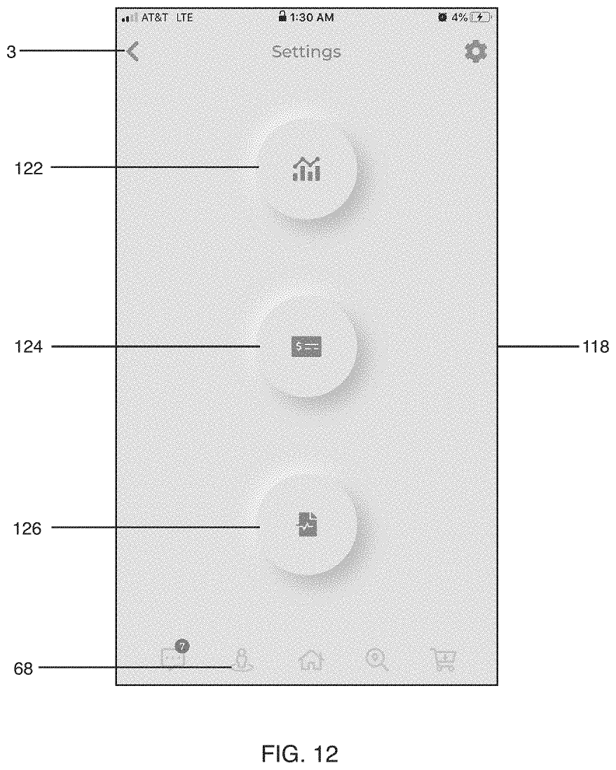

FIG. 12 shows a screenshot of the personal user settings page 118. On this settings page 118 the user can click the back button 3 to return to user account page 60. On this page 118 the user has three button options to either choose to click the user analytics icon button 122, the user finance icon button 124, or the user filing data icon button 126. The user personal account icon 68 will be highlighted when user is on this settings page 118.

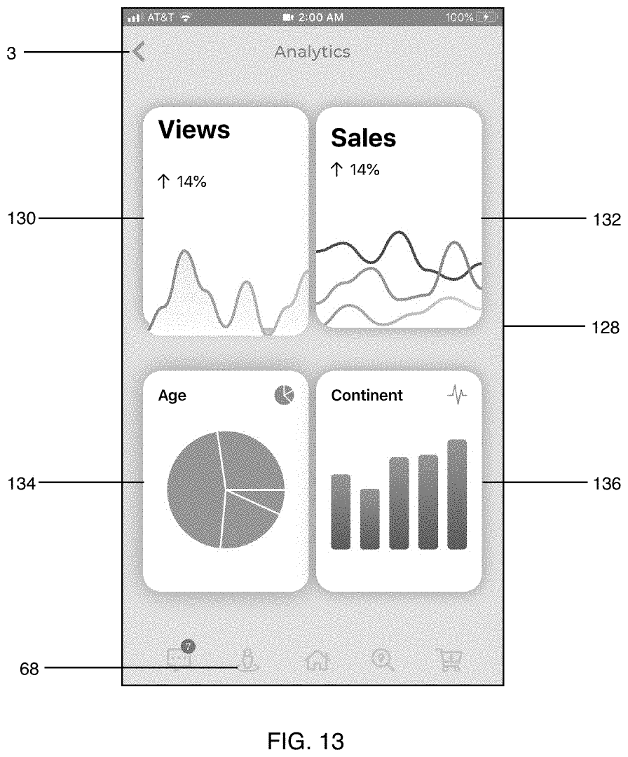

FIG. 13 shows a screenshot of the personal user store analytics page 128. On the analytics page 128 the user can click the back button 3 to return to the personal user settings page 118. On this analytics page 128 the user has four graph options displaying the users store views 130, the users store sales 132, the users store sales/views by age 134, and the users store sales/views by continent 136. The user personal account icon 68 will be highlighted when user is on this analytics page 128.

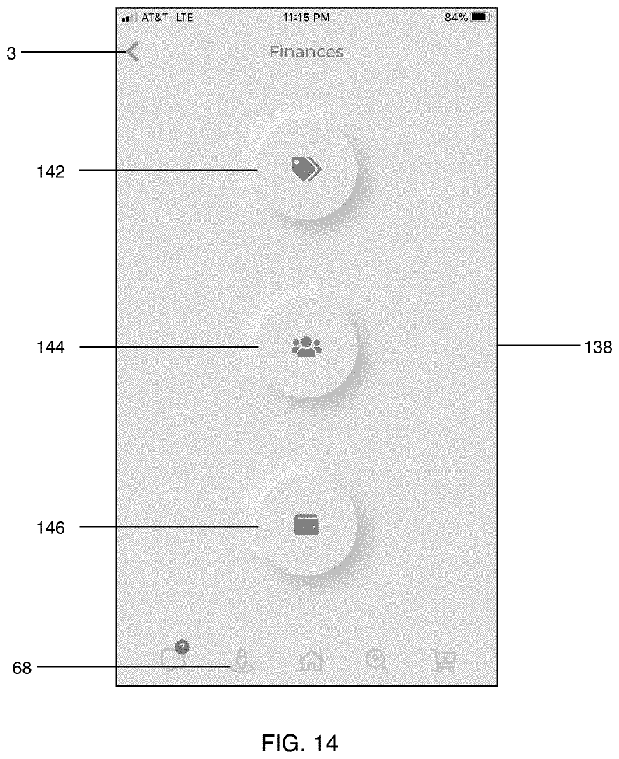

FIG. 14 shows a screenshot of the personal user finance page 138. On this finance page 138 the user can click the back button 3 to return to the personal user settings page 118. On this finance page 138 the user has three button options to either choose to click the user store sales icon button 142, the user store customers icon button 144, or the user wallet icon button 146. The user personal account icon 68 will be highlighted when user is on this user finance page 138.

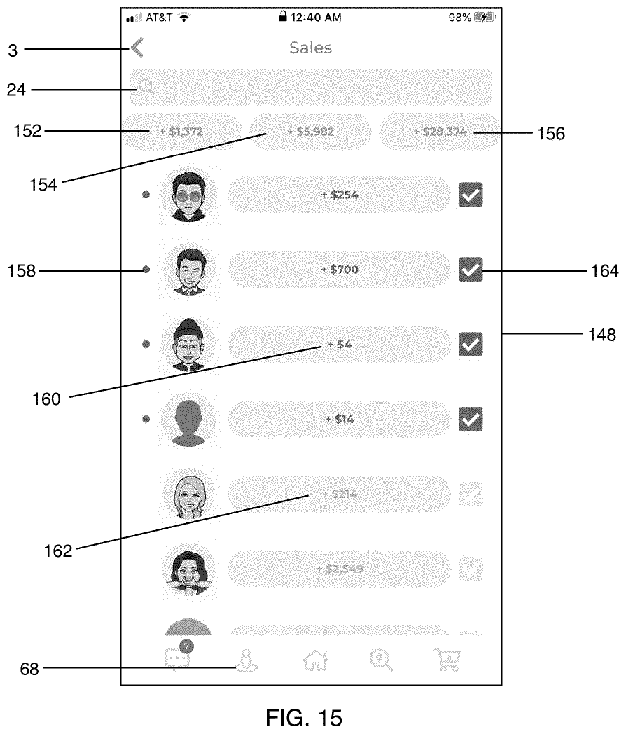

FIG. 15 shows a screenshot of the users store sales page 148. On this sales page 148 the user can click the back button 3 to return to the personal user finance page 138. On this sales page 148 the user can use the search bar 24 to search through current and past sales. On this sales page 148 the user can view their weekly profit 152, monthly profit 154, and their annual profit 156. This sales page 148 also displays the most recent unread customer sales 158, as well as the amount of the product sale 160. There is also a check icon to notify that the product has shipped 164. Once an unread customer sale 158 has been viewed, it is displayed as a read customer sale 162. The user personal account icon 68 will be highlighted when user is on this user finance page 148.

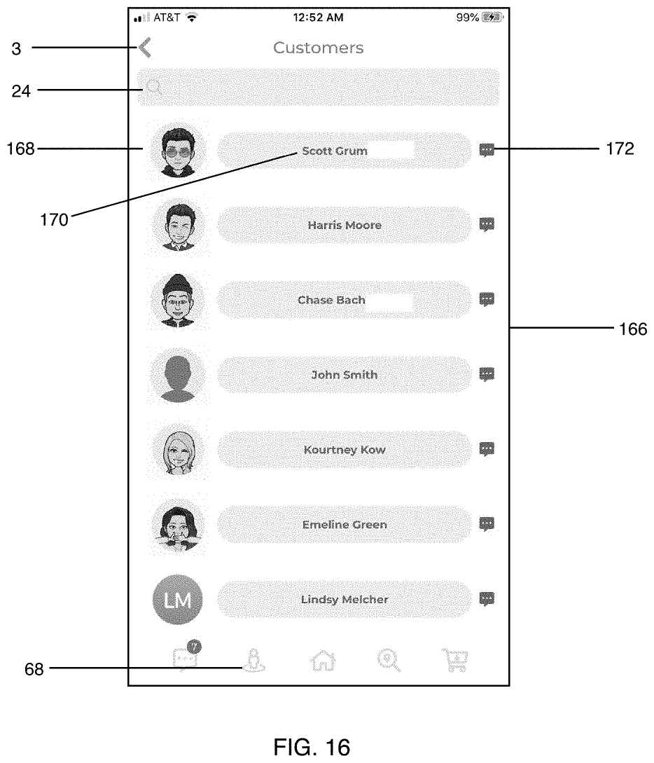

FIG. 16 shows a screenshot of the user's store customers page 166. On the customers page 166 the user can click the back button 3 to return to the personal user finance page 138. On the store customer's pate 166, the user can use the search bar 24 to search through current and past customers. On the store customer's page 166, the customer avatar 168 is displayed next to their name 170. The user can click the store customer message icon 172 to write a custom message to the specific customer. The user personal account icon 68 will be highlighted when user is on this user store customers page 166.

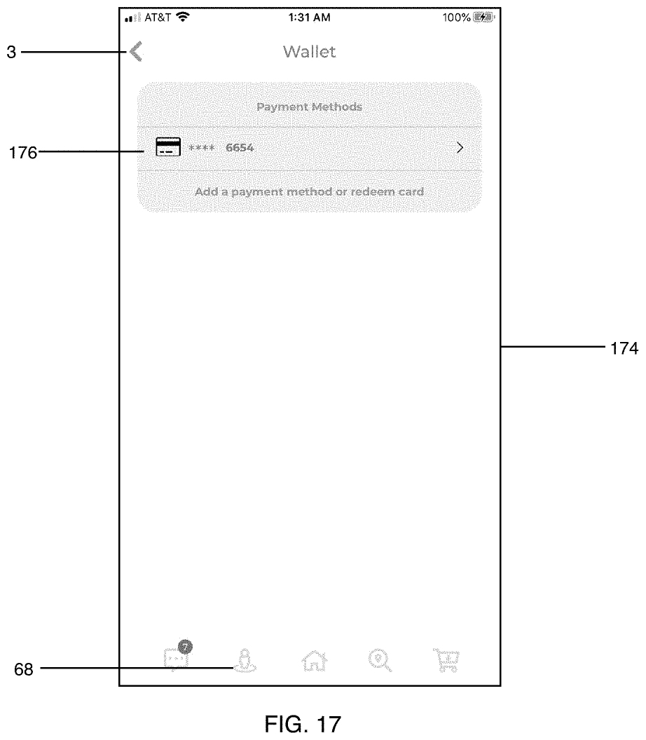

FIG. 17 shows a screenshot of the user's wallet page 174. On the wallet page 174 the user can click the back button 3 to return to the personal user finance page 138. On the wallet page 174 the users card information 176 is displayed. The user personal account icon 68 will be highlighted when user is on this user wallet page 174.

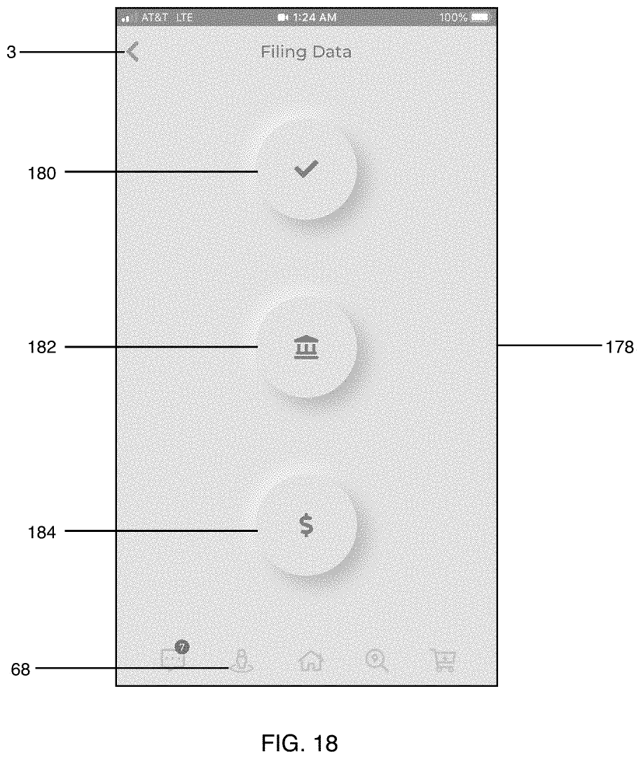

FIG. 18 shows a screenshot of the user filing data page 178. On this filing data page 178 the user can click the back button 3 to return to the personal user settings page 118. On this filing data page 178 the user has three button options to either choose to click the user verification icon button 180, the user government icon button 182, or the user accounting icon button 184. The user personal account icon 68 will be highlighted when user is on this user filing data page 178.

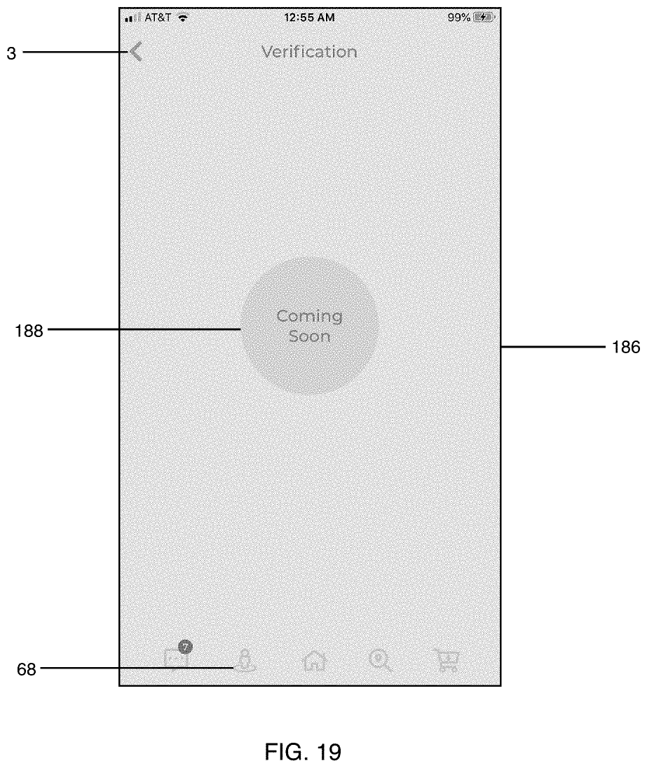

FIG. 19 shows a screenshot of the user verification page 186. On this verification page 186 the user can click the back button 3 to return to the user filing data page 178. Where the coming soon display 188 is located on this verification page 186 the user will be able to verify their identity and payment methods for future business purposes. The user personal account icon 68 will be highlighted when user is on this user verification page 186.

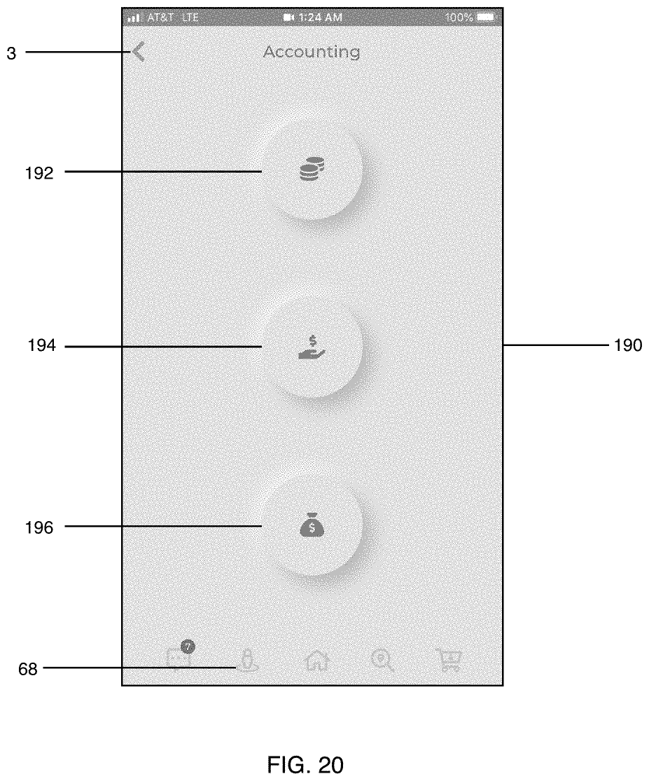

FIG. 20 shows a screenshot of the user accounting page 190. On this user accounting page 190 the user can click the back button 3 to return to the filing data page 178. On the user accounting page 190 the user has three button options to either choose to click the user taxes icon button 192, the user investments icon button 194, or the user retirement icon button 196. The user personal account icon 68 will be highlighted when user is on this user accounting page 190.

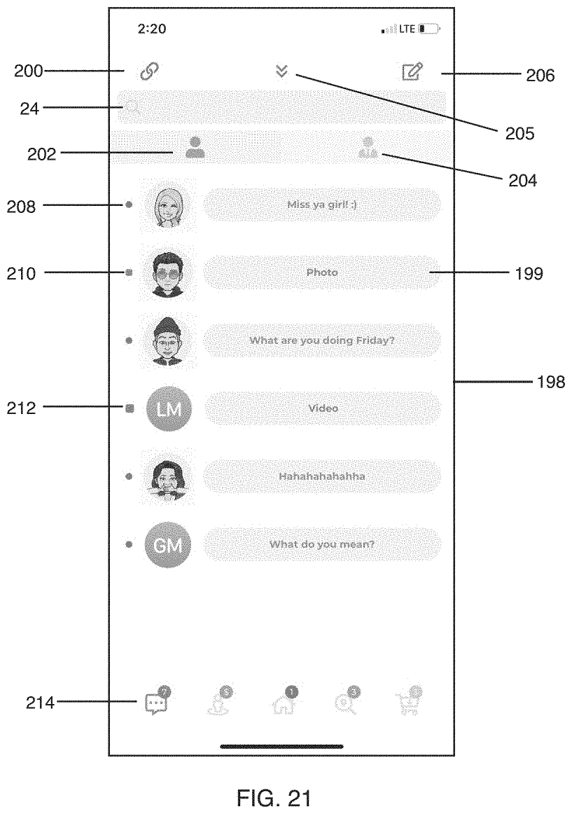

FIG. 21 shows a screenshot of the user's messenger page 198. On this messenger page 198 the user can use the search bar 24 to search through current and past messages. On this messenger page 198 the user can click the light links icon 200 to see all of their light links 114. The user can also click the quick reply icon 205 to quickly reply to all unread messages. The user can also click the new message icon 206 to quickly write a new message to a customer or light link 114. The new light messages 199 from their light links 114 is shown under the light links messages tab 202. The new customer messages are shown under the store customer messages tab 204. When a new message comes in, it appears at the top of the page under the light links messages tab 202 with a new text message icon 208. When a new photo message comes in, it appears at the top of the page under the light links messages tab 202 with a new photo message icon 210. When a new video message comes in, it appears at the top of the page under the light links messages tab 202 with a new video message icon 212. The messenger icon 214 will be highlighted when user is on this messenger page 198.

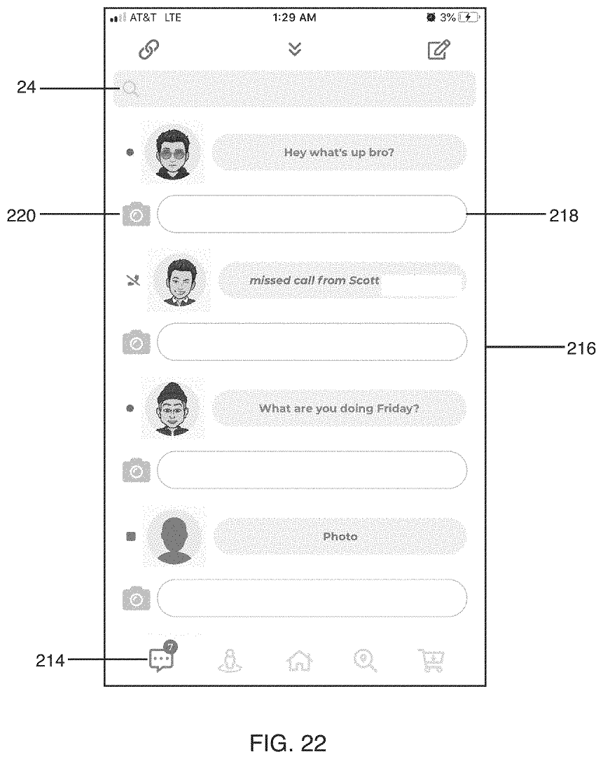

FIG. 22 shows a screenshot of the quick reply page 216. On this quick reply page 216 the user can use the search bar 24 to search through current and past light messages 199. On this quick reply page 216 a drop down message bar 218 appears below each light message 199 so that the user may reply quicker than usual. Next to the quick reply message bar 218 is the photo message icon 220 giving the user the option to reply via photo. The messenger icon 214 will be highlighted when user is on this messenger page 198.

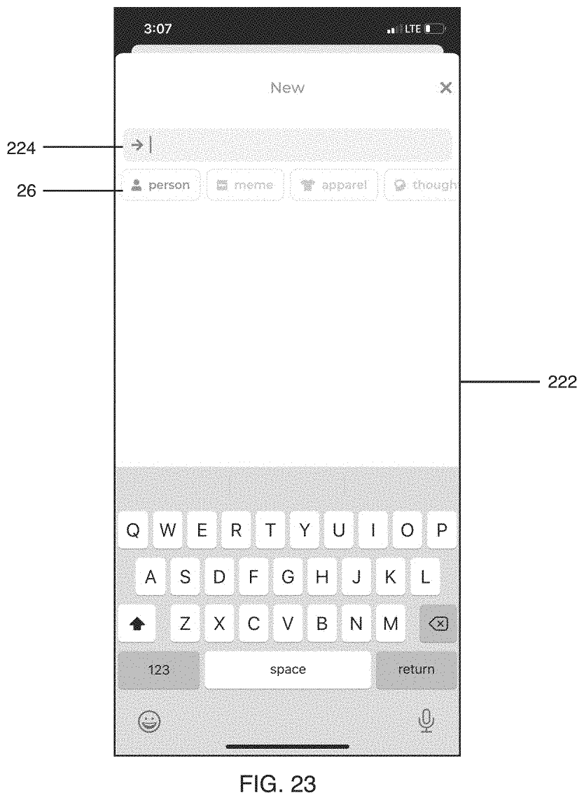

FIG. 23 shows a screenshot of the new message page 222. On this new message page 222 the user can use the new message search bar 224 to search through the categories list 26 in order to send an instant light message 199.

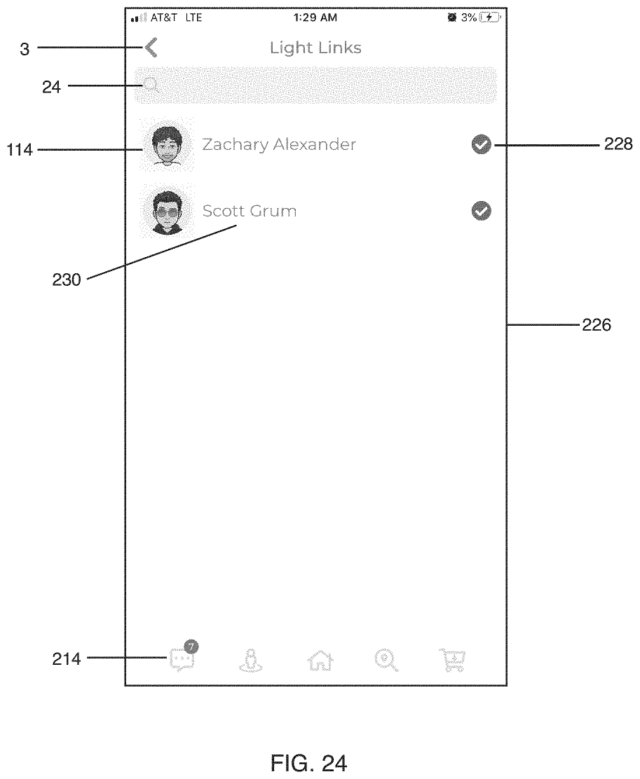

FIG. 24 shows a screenshot of the light link page 226. On this light links page 226 the user can click the back button 3 to return to the user messenger page 198. On this light link page 226 the user can use the search bar 24 to search through all light links 114. On this light links page 226 a list of light links 114 will be displayed including their light link name 230. A verified light link icon will be shown next to the light link name 230 exemplifying that the user and the light link 114 are linked. The messenger icon 214 will be highlighted when user is on this light link page 226.

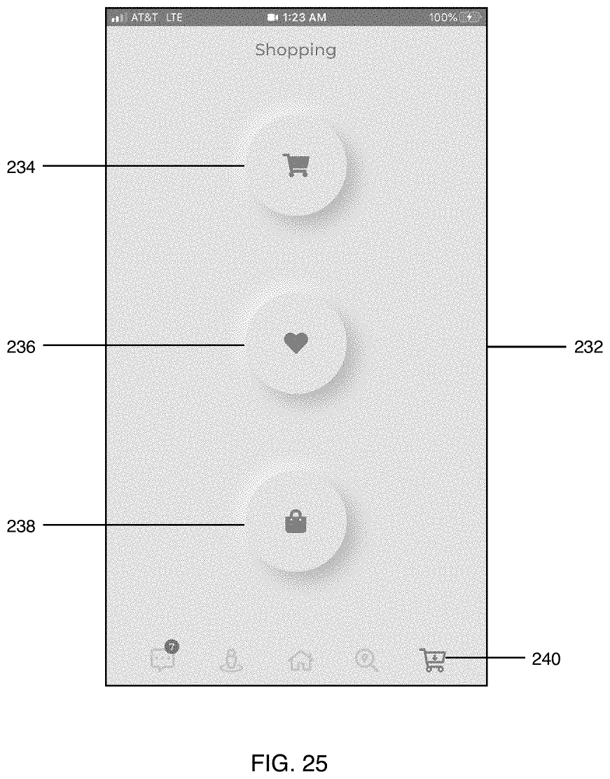

FIG. 25 shows a screenshot of the user shopping page 232. On this user shopping page 232 the user has three button options to either choose to click the user cart icon button 234, the user wishlist icon button 236, or the user purchases icon button 238. The user shopping icon 240 will be highlighted when user is on this user shopping page 232.

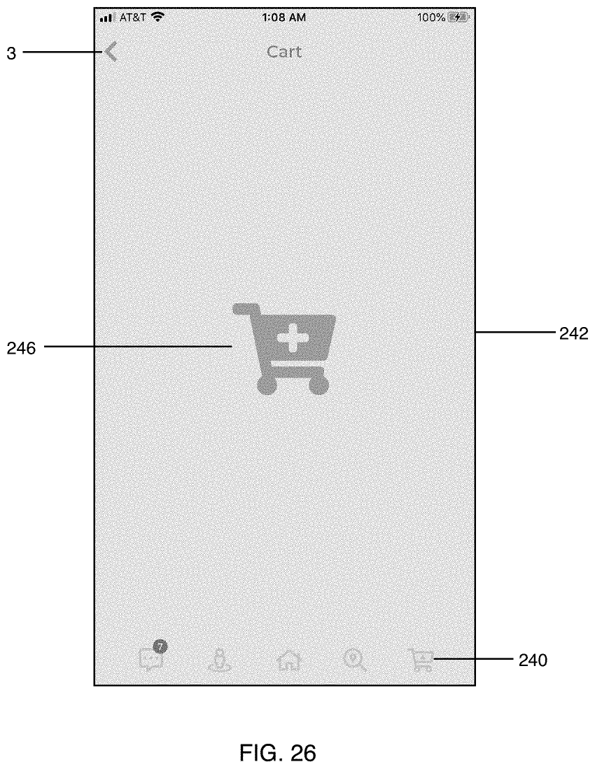

FIG. 26 shows a screenshot of the user cart page 242. On this user cart page 242 a list of selected products will be displayed for the user to further follow through on ordering the selected products. When the cart is empty an empty cart icon 246 will be displayed. The user shopping icon 240 will be highlighted when user is on this user cart page 242.

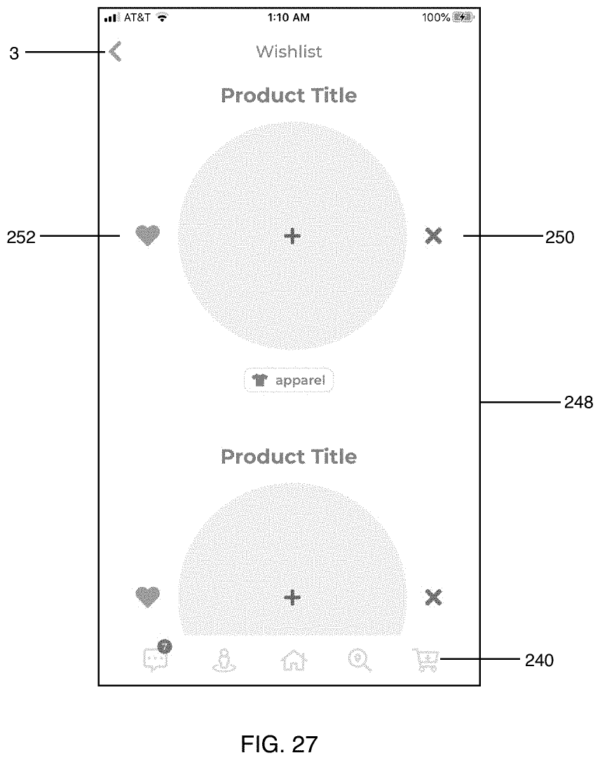

FIG. 27 shows a screenshot of the user wishlist page 248. On this wishlist page 248 the user can click the back button 3 to return to the user shopping page 232. On this user wishlist page 248 a list of selected products 252 will be displayed for the user to further follow through on ordering the selected products or not. The user will have the option to delete products from this list by clicking the delete product icon 250. The user shopping icon 240 will be highlighted when user is on this user wishlist page 248.

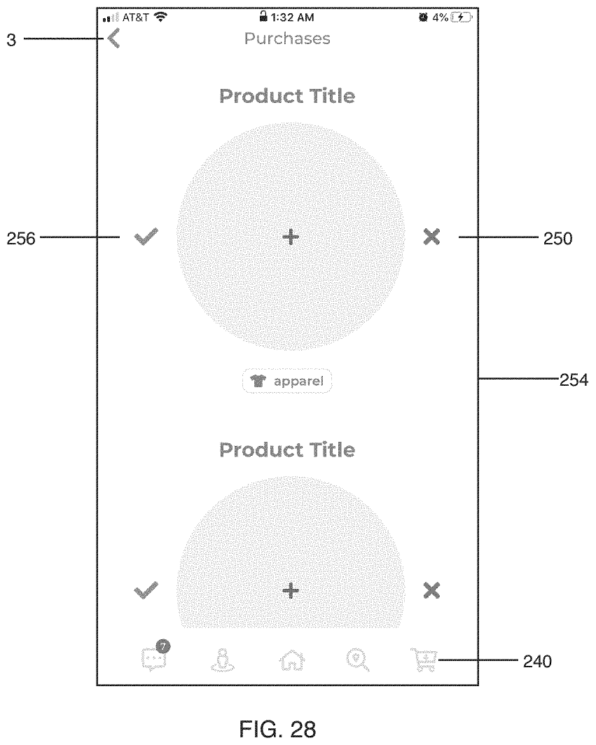

FIG. 28 shows a screenshot of the user purchases page 254. On this purchases page 254 the user can click the back button 3 to return to the user shopping page 232. On this user purchases page 254 a list of selected products 252 will be displayed showing all the users verified purchases 256. The user will have the option to delete products from this list by clicking the delete product icon 250. The user shopping icon 240 will be highlighted when user is on this user purchases page 254.

The online public store 102 will show only that store's products and/or services offered for sale. Categories 34 categorize the products for sale and/or services for sale offered from all of the online public stores 102. Examples of categories 34 includes, but is not limited to, accessories, photography, music, automotive, apparel, art, books, furniture, homes, movies, transportation, development, design, electronics, collectibles, labor services, healthcare, used products, daycare, health, exercise, and any other desired category. The categories can also include information and/or items not for sale, such as podcasts, blogs, posts, pictures, spirituality, questions, job offers, schedulers for meetings, common interest groups, discussion groups, and any other desired information.

The server 150 can contain software modules that are downloadable to the user interface devices 140. The software modules can include a 1LM system module that can include a storefront software module, a messaging software module, a blogging software module, a jobs software module, an akashic records software module, a photo software module, a location software module, and a personal records software module.

The database preferably includes a user personal information database, user storefront information database, akashic records database, a photo database, a location database and a message database. The user personal information database includes personal information about a user, for example, name, address, age, sex, bank accounts, credit cards, and other personal information. The user storefront database includes information regarding the electronic store, such as products for sale, sale price, inventory, sales, job offerings, and any other desired business information. The messaging database can store messages from users for a set time period, upon which the system will delete the messages from the messaging database. The photo database can store photos for a set time period, upon which the system will delete the photos from the photo database. The kashic records database will store messages, photos and other information designated by the user. The location database can store information regarding the maps display page.

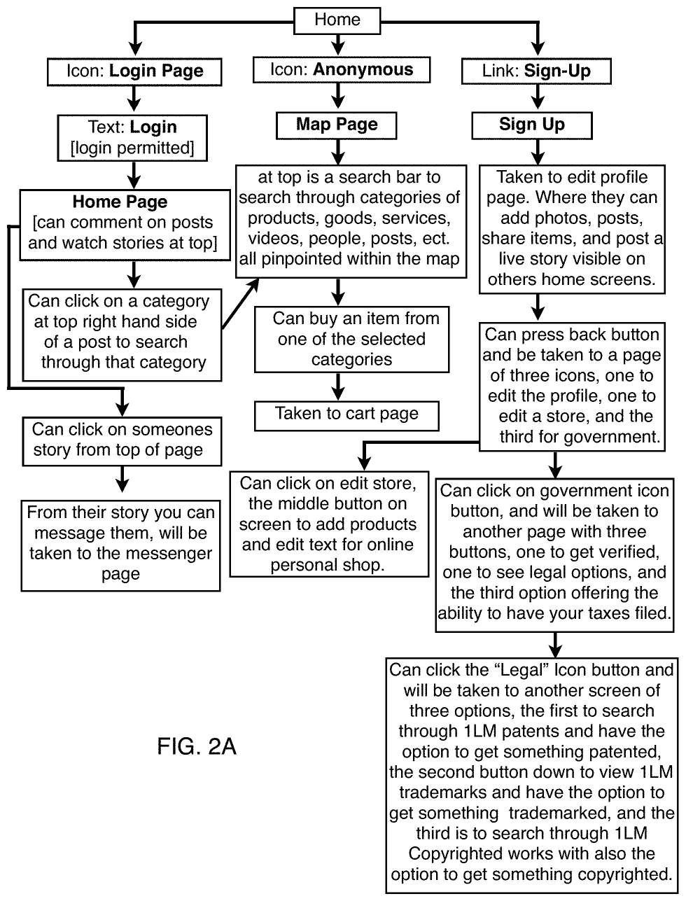

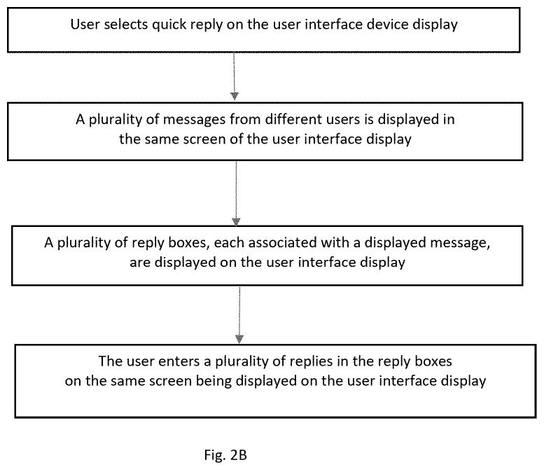

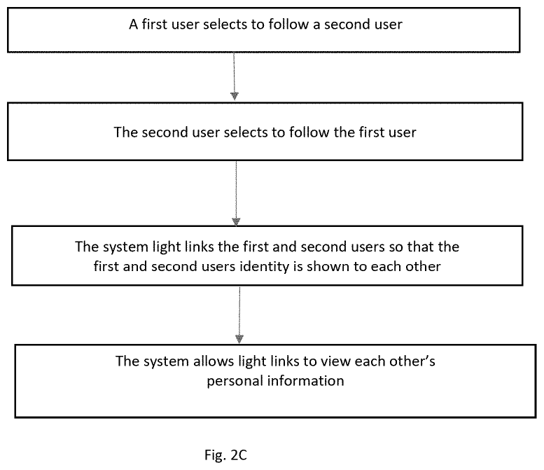

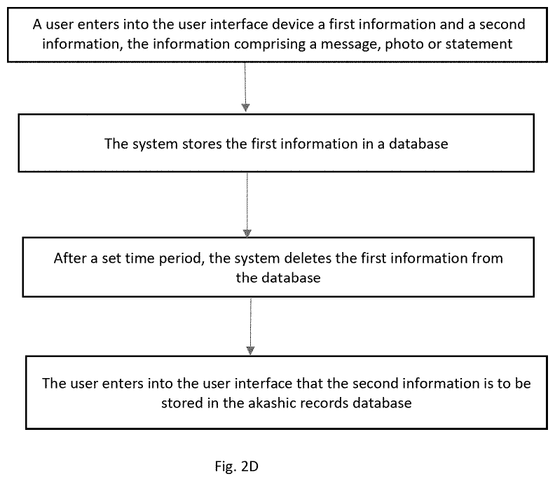

FIGS. 2A-2B show flow charts of the different actions that can be entered by a user into the user interface device 120 in the screenshots shown in FIGS. 3-28 described above.

As used herein, “light links” refers to a group of users that are following each other. A first user can only be light linked with a second user if the second user also follows the first user. The term “following” in reference to a user can also be referred to as a link request.

As used herein, “light followers” means a user that follows a specific user's store.

As used herein, “akashic records” is a user's personal records that are retained (not automatically deleted) as long as the user desires to have those records retained. If a user becomes deceased, the aka shic records will be retained.

As used herein, “quick reply” is an option that the user can select in which a plurality of messages from different users are concurrently displayed on the same screen and the user can enter replies to a plurality of different users on the same screen.

“A” or “an” means “at least one” or “one or more” unless otherwise indicated.

“Comprise”, “have”, “include” and “contain” (and their variants) are open-ended linking verbs and allow the addition of other elements when used in a claim.

Use of “is” and “the” in the description are non-limiting in regards to the claims and are only used to describe the exemplary screenshots as being currently produced according to the present invention.

### FIGURE REFERENCE NOS.

100 1LM System
120 User interface
140 Network
150 Server
2 Login Page
3 Back Button Icon
4 1LM Logo
6 Login Icon
8 Search Icon
10 Sign-up Link
12 Sign-up Page
13 Free Profile Option
14 VIP Account Option
16 Fast Five Account
18 Boss Account Option
20 All Access Account Option
22 Search Page
24 Search Bar
26 Categories List
28 Online Business Map Finder
30 Advertised, Local, and new online store fronts
32 Home Page
34 Category
36 Notifications Tab
38 Recent Uploaded Story (private and public options)
40 Light Linked Accounts and Followed Stores Recent Posts Tab
42 User Profile Photo, Name and Story 38 accessibility if user posted a recent Story 38
44 Location of User
45 Published Profile
46 User Post
48 User Post Caption
50 User Comment
52 Visible User Views
54 Home Icon
56 Notifications Page
58 User Notification
60 User Account Page
62 User Profile Settings Icon Button
64 User Store Settings Icon Button
66 User Account Settings Icon Button
68 User Personal Account Icon
70 Profile Settings Page
72 Profile Background Image
74 Light Links Icon Box
76 Profile Photo
78 Profile Bio
80 Personal Videos
82 Personal Photos
84 Online Store Settings Page
86 Online Store Light Desk
88 Avatar
90 Light Followers Icon Box
91 Store Name
92 User Store Profile Photo and Story 38 accessibility if a recent Story 38 was posted
94 Store Logo
95 Purse
96 Store Background Image
98 Light Show
100 1LM System
102 Public Online Store
104 Online Store Settings Page Continued
105 Store Blog Posts
106 Category Carousel
108 Collection Title
110 Collection Bio
112 Product
114 Light Links
116 Light Followers
118 User Settings Page
120 User Interface Device
122 User Analytics Icons
124 User Finance Icon
126 User Filing Data Icon
128 User Store Analytics Page
130 User Store Views
132 User Store Sales
134 Store Sales/Views by Age
136 Store Sales/Views by Continent
138 User Finance Page
140 Network
142 User Store Sales Icon
144 User Store Customers Icon
146 User Wallet Icon
148 User Store Sales Page
150 Server
152 User Weekly Profit
154 User Monthly Profit
156 User Annual Profit
158 User Unread Customer Sale
160 User Product Sale Amount
162 User Read Customer Sale
164 Check Icon to Notify that Product has Shipped
166 User Store Customers Page
168 User Store Customer Avatar
170 User Store Customer Name
172 User Store Customer Message Icon
174 User Wallet Page
176 User Card Information
178 User Filing Data Page
180 User Verification Icon
182 User Government Icon
184 User Accounting Icon
186 User Verification Page
188 Coming Soon Display
190 User Accounting Page
192 User Taxes Icon
194 User Investments Icon
196 User Retirement Icon
198 User Messenger Page
199 Light Message
200 User Light Links Icon
202 User Light Links Messages Tab
204 User Store Customer Messages Tab
205 User Quick Reply Icon
206 New Message Icon
208 New Text Message Icon
210 New Photo Message Icon
212 New Video Message Icon
214 Messenger Icon
216 Quick Reply Page
218 Quick Reply Message Bar
220 Photo Message Icon
222 New Message Page
224 New Message Search Bar
226 Light Links Page
228 Verified Light Link Icon
230 Light Link Name
232 User Shopping Page
234 User Cart Icon
236 User Wishlist Icon
238 User Purchases Icon
240 Shopping Icon
242 User Cart Page
246 User Empty Cart Icon
248 User Wishlist Page
250 Delete Product Icon
252 Selected Product Icon
254 User Purchases Page
256 User Verified Purchase

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, steps and/or embodiments, the invention is not intended to be limited to the particulars disclosed herein. Rather, the invention extends to all functionally equivalent structures, processes and uses, such as are within the scope of the appended claims. Those skilled in the art, having the benefit of the teachings of this specification, may affect numerous modifications thereto and changes may be made without departing from the scope and spirit of the invention.

1. A system for providing an electronic storefront comprising:
a cloud based server connected to a network, the cloud based server in communication with or comprising at least one non-volatile memory, a database stored in the non-volatile memory, and the database comprising a user personal information database, a user storefront database, an akashic records database, a photo database, and a message database;
a plurality of user interface devices in communication with the cloud based server via the network;
message software running on the plurality of user interface devices configured for sending messages between selected user interface devices and displaying the messages on the selected user interface devices;
the message database containing the messages, and the system is configured to automatically delete the messages after a set time period;
messages selected by users saved in the akashic records database, and the system is configured to not automatically deleted the messages saved in the akashic records database;
the system is configured so that each user has an anonymous avatar to avoid identification of the user by other users; and
the system is configured to allow users to follow other users, users following each other are designated as light linked, and light linked users see an identity of each other.

2. The system according to claim 1, further comprising the system is configured to provide a quick reply option that displays a plurality of messages from a plurality of users and boxes associated by each message for entering a reply by the user.

3. The system according to claim 1, further comprising the system is configured to display store icons that a user can select to enter a desired store and a map.

4. The system according to claim 1, further comprising the system is configured to display an interactive map configured to display information regarding a user selected location.

5. The system according to claim 1, further comprising the system is configured to display a user personal profile search bar on the user interface device for the user to enter a search term to search the user's personal profile posts.

6. The system according to claim 1, further comprising the system is configured to display on the display an anonymous avatar of a store owner in the store.

7. A method for providing an electronic storefront comprising:
providing a cloud based server connected to a network, the cloud based server in communication with or comprising at least one non-volatile memory, a database stored in the non-volatile memory, and the database comprising a user personal information database, a user storefront database, an akashic records database, a photo database, and a message database;
a plurality of users comprising a first user, a second user, a third user and a fourth user, each connecting to the server over the network using associated a first user interface device, a second user interface device, a third user interface device and a fourth interface device;
downloading and running on each of the user interface devices system software configured to provide associated a first user electronic storefront, a second user electronic storefront, a third user electronic storefront and a fourth electronic storefront;
each user inputting user information into the user personal information database, including anonymous avatars;
the first user sending a first message from the first user interface device to the second user interface device for viewing by the second user, and the second user viewing a first user avatar and the first message;
storing the first message in the message database for set time period and the system automatically deleting the message from the message database after the set time period;
the third user using the third user interface device to select following the fourth user;
the forth user using the fourth user interface device to select following the third user, and since the third user and the forth user are following each other the system designating the third user and the fourth user as light linked so that the third user and fourth user are identified to each other and are no longer anonymous to each other; and
the third user saving the second message in the akashic records database so that the third message is not automatically deleted by the system.

8. The method according to claim 7, further comprising the first user setting up a first user storefront including at least one product for sale.

9. The method according to claim 7, further comprising a user selecting a quick reply option and the user interface device displaying a plurality of messages from a plurality of users and boxes associated by each message for entering a reply by the user.

10. The method according claim 9, the user entering a reply to a first message and a reply to a second message while the first and second messages are displayed.

11. The method according to claim 7, further comprising displaying store icons and a map on the user interface device, and the user selecting a store on the display to enter.

12. The method according to claim 7, further comprising displaying an interactive map, the user selecting a location on the map and the map displaying information regarding the user selected location.

13. The method according to claim 7, further comprising displaying a user personal profile search bar, and the user entering a search term to search the user's personal profile posts.

14. The method according to claim 7, further comprising the user selecting a store icon to enter on the display of the user interface device, and displaying an anonymous avatar of the store owner in the store on the display.

15. The method according to claim 14, wherein the anonymous avatar is displayed behind a desk or counter in the store on the display.
